(19) United States
(12) Patent Application Publication
(10) Pub. No.: US 2023/0362211 A1
(43) Pub. Date: Nov. 9, 2023

(54) METHOD AND USER EQUIPMENT

(71) Applicant: INNOPEAK TECHNOLOGY, INC., Palo Alto, CA (US)

(72) Inventors: Xin XU, Palo Alto, CA (US); Yongsheng SHI, Palo Alto, CA (US); Jaehyeuk YANG, Palo Alto, CA (US)

(21) Appl. No.: 18/353,853

(22) Filed: Jul. 17, 2023

Related U.S. Application Data
(63) Continuation of application No. PCT/US2022/014363, filed on Jan. 28, 2022.
(60) Provisional application No. 63/143,325, filed on Jan. 29, 2021.

(51) Int. Cl. H04L 65/1069; H04W 36/00

(52) U.S. Cl. CPC H04L 65/1069; H04W 36/0088

(57) ABSTRACT

Methods and a user equipment (UE) are provided. The method comprises determining whether a UE is performing a voice over internet Protocol (VoIP) call setup procedure. Upon a determination that the UE is performing a VoIP call setup, transmission of measurement report information to a network in which the UE Is operating is selectively enabled or disabled until the VoIP call setup procedure is complete. Selective enablement of the transmission of the measurement report information depends upon a further determination that a serving cell currently serving the UE fails to meet a stability threshold. Selective disablement of the transmission of the measurement report information occurs when redirection or handover of the UE pursuant to the transmission of the measurement report information is a possibility.

### CROSS-REFERENCE TO RELATED APPLICATIONS

This application is a continuation of International Application No. PCT/US2022/014363, filed Jan. 28, 2022, which claims priority to U.S. Provisional Application No. 63/143,325, filed Jan. 29, 2021, the disclosures of which are hereby incorporated by reference in their entireties.

### TECHNICAL FIELD

The disclosed technology relates generally to voice call setup, and more particularly to methods and a user equipment (UE), for preventing user equipment (UE) measurement reporting to avoid triggering a switch between radio access technologies (RATs) or handoff prior to completing a call setup procedure.

### DESCRIPTION OF RELATED ART

With the advent of wireless/mobile communications came various technologies, such as the global system for mobile communication (GSM), code division multiple access (CDMA), etc. Moreover, while early wireless/mobile communications systems were reliant on circuit switched networks, later-developed wireless/mobile communications systems moved to packet switched networks. When, for example, a packet switched network, such as a long term evolution (LTE) network, was not available, a feature referred to as circuit switched fallback (CSFB) was used. That is, when an LTE (packet switched) network was not available to support a call, for example, a user equipment (UE) could “fall back” to a legacy/more accessible, circuit switched network, such as a third generation wireless (3G) network.

Similarly, voice over LTE (VoLTE) and voice over new radio (VoNR) can refer to packetizing voice over the Internet Protocol (IP) and transporting signaling/data over a 4G/LTE packet switched data path or the fifth generation wireless (5G) user plane (UP). Evolved packet system (EPS) fallback is another mobility procedure or mechanism where a UE may change radio access from 5G to fourth generation wireless (4G) technologies.

### Terms

The following acronyms are used throughout the drawings and/or descriptions, and are provided below for convenience although other acronyms may be introduced:
NR: New Radio
SA: Stand-Alone
VoNR: Voice Over NR
VoLTE: Voice Over LTE
MR: Measurement Report

### BRIEF SUMMARY

In a first aspect, a method is provided. The method comprises determining whether a user equipment (UE) is performing a voice over internet Protocol (VoIP) call setup procedure. Upon a determination that the UE is performing a VoIP call setup, transmission of measurement report information to a network in which the UE Is operating is selectively enabled or disabled until the VoIP call setup procedure is complete. Selective enablement of the transmission of the measurement report information depends upon a further determination that a serving cell currently serving the UE fails to meet a stability threshold. Selective disablement of the transmission of the measurement report information occurs when redirection or handover of the UE pursuant to the transmission of the measurement report information is a possibility.

In a second aspect, a user equipment (UE) is provided. The UE comprises a processor, and a memory unit. The memory unit includes computer code that when executed causes the processor to: enable transmission of measurement report information to a network in which the UE is operating while the UE is performing a voice over Internet Protocol (VoIP) call setup procedure upon a determination that a serving cell currently serving the UE fails to meet a stability threshold; and disable transmission of the measurement report information when redirection or handover of the UE pursuant to the transmission of the measurement report information is a possibility.

In a third aspect, a method is provided. The method comprises, pursuant to receipt of a handover instruction, determining whether a user equipment (UE) is performing a voice over internet Protocol (VoIP) call setup procedure. The method comprises further determining whether the UE transmitted a measurement report prior to receipt of the handover instruction. Upon a determination that no measurement report was transmitted by the UE ignoring the handover instruction and continue with the VoIP call setup procedure.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example network in which embodiments disclosed herein may be implemented in accordance with some embodiments.

FIG. 2 illustrates an example of a handover.

FIG. 3 illustrates an example handover procedure based on measurement reports.

FIG. 4A illustrates example operations for selectively enabling or disabling measurement reporting by a UE in accordance with various embodiments.

FIG. 4B illustrates an example of an Evolved Packet System (EPS) fallback call setup procedure.

FIG. 4C illustrates an example of Voice over New Radio call setup procedure.

FIG. 5 is an example computing component that may be used to implement various features of embodiments described in the present disclosure.

The figures are not exhaustive and do not limit the present disclosure to the precise form disclosed.

### DETAILED DESCRIPTION

Various wireless technology standards enable communications between connected electronic devices, such as the aforementioned user equipment (UEs). 802.11-based wireless communications (Wi-Fi), third-generation wireless (3G), fourth-generation wireless (4G), Long Term Evolution (LTE), and fifth-generation wireless (5G) are examples of existing radio access technologies (RATs) that have corresponding standards that dictate how communications are performed therewith. These RATs, as well as newly developed RATs and standards, support Internet Protocol (IP) Multimedia Subsystem (IMS) and/or Short Message Service (SMS) communications between corresponding devices. Together, these technologies provide connectivity to most current and future cellular or wireless devices.

In some deployments of any RAT, voice calls and communications employ IMS signaling and/or media. Voice and video communications services in the RATs can be implemented on top of IP data connections such that the IMS provides the services for the corresponding RATs. In other words, the IMS provides voice communications as an application service. For example, in 5G New Radio (5G NR), voice calls may be supported entirely over a packet switched (PS) domain with the IMS signaling and/or media, for example, implemented as end-to-end voice over IP (VoIP) connections managed by the IMS.

However, issues can arise when a call is being set up as a VoLTE, VoNR, or EPS fallback call, but the UE is redirected or is triggered to perform a handover to another RAT/cell before the call is connected/established. That is, during operation, a UE typically performs measurements for determining link quality in a network, and sends the resulting measurements in/as measurement reports to the network in which it is operating. If the measurement report reflects values or operating states that necessitate or suggest redirection or handover, the UE will move from one RAT/cell to another. If this occurs before call set up is complete, the call will ultimately fail.

In order to avoid the negative user experience of a dropped call, embodiments of the present disclosure prevent or limit the transmission of measurement reports from a UE to its network (such as a base station/node B/eNodeB/gNB), e.g., until after VoLTE, VoNR, or EPS fallback call setup has been completed. In this way, call setup operations can be completed so the call can progress without disruption or interference. After call setup is complete, “normal” operation can resume and the transmission of measurement reports from a UE can proceed/resume, and redirection or handovers can be performed accordingly. In some embodiments, particular events that could cause the triggering of a redirection or handover are not reported in measurement reports. Thus, even if a measurement report is sent by a UE, the information in the measurement report will not include redirection/handover triggering-information.

In other embodiments, or in conjunction with the aforementioned embodiment(s), when the serving cell call quality/state is worse than a given threshold, and there is a risk of radio link failure, the UE may enable the transmission of measurement reports regardless of whether or not the UE is undergoing call setup. Because there is a probability that any established call might fail anyway, the UE intervening with the transmission of a measurement report can mitigate this risk.

In still other embodiments, a UE may ignore a handover command, in the event the handover is a blind handover. That is, blind handovers can be triggered without receipt of a measurement report from a UE. In order to avoid a handover prior to VoLTE/VoNR/EPS fallback call setup, the UE may ignore the command/request to perform an intra- or inter-RAT (LTE/NR) handover if the UE did not send a measurement report preceding the blind handover command/request. In such a scenario, despite receiving instructions/commands to perform a handover, the UE can continue to perform the in-progress VoLTE/VoNR/EPS fallback call setup operation(s). Accordingly, voice call success rates can increase, and negative user's call setup/progress experience can be avoided.

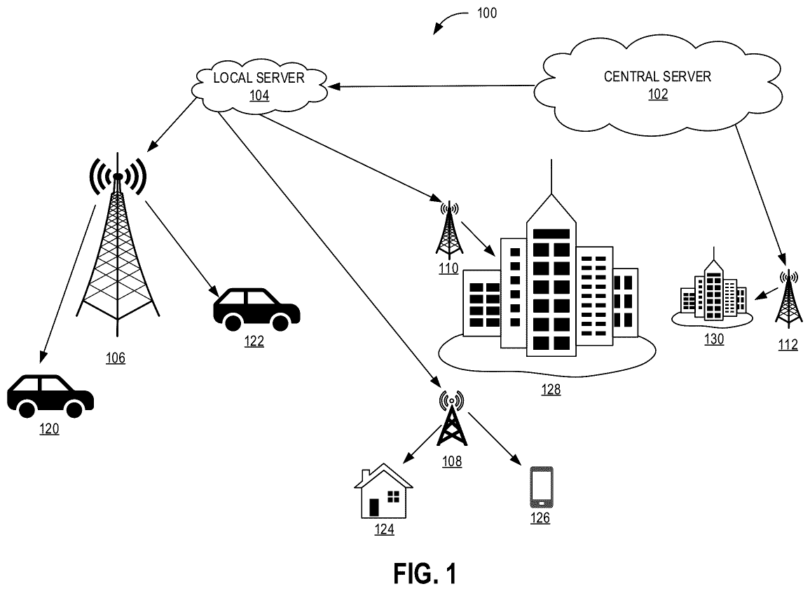

Before describing the details of the various embodiments contemplated herein, it would be beneficial to describe a communications network in which such embodiments may be implemented or utilized. FIG. 1 illustrates an example network 100 in which or with which various embodiments of the present disclosure may be implemented. A mobile network can be thought of as comprising two component networks, the radio access network (RAN) and the core network.

A mobile network's RAN may include various infrastructure, e.g., base stations/cell towers, masts, in-home/in-building infrastructure, and the like. The RAN allows users of devices (also referred to as UEs, e.g., smartphones, tablet computers, laptops, vehicle-implemented communication devices (e.g., vehicles having vehicle-to-vehicle (V2V) capabilities), to connect to the core network. FIG. 1 illustrates a plurality of small base stations or small cells and macro base stations or macro cells, i.e., macro cells 106, 110, and 112, and small cell 108.

Macro cells can refer to (tall, high-powered) “macro” base stations/cell towers that are able to maintain network signal strength across long/large distances. Macro cells may use multiple input, multiple output (MIMO) antennas that may have various components that allow data to be sent and/or received simultaneously. In the example network 100 of FIG. 1, macro cell 106 may provide wireless broadband coverage/communications to vehicles 120 and 122. Macro cell 110 may provide broadband service to an area, such as a city or municipality 128. Likewise, macro cell 112 may provide broadband coverage to an area, such as a city or municipality 130.

Small cells can refer to wireless transmitters/receivers implemented as micro base stations designed to provide coverage to areas smaller than those afforded coverage by macro cells, e.g., on the order of about 100 meters (m) to 200 m for outdoor 5G small cells. Indoor 5G small cell deployments may provide coverage on the order about 10 m. Small cells can be mounted or integrated into/onto street lights, utility poles, buildings, etc., and like macro cells, may also leverage massive MIMO antennas. In the example network 100 of FIG. 1, small cell 108 provides broadband coverage to a house 124 and smartphone 126.

The core network may comprise the mobile exchange and data network used to manage the connections made to/from/via the RAN. As illustrated in FIG. 1, the core network of network 100 may include central server 102 and local server 104. Central server 102 is shown to effectuate broadband service to area 130 by way of macro cell 112. Central server 102 may also operatively connect to local server 104, which in turn, provides broadband connectivity by way of macro cells 106 and 110, as well as small cell 108.

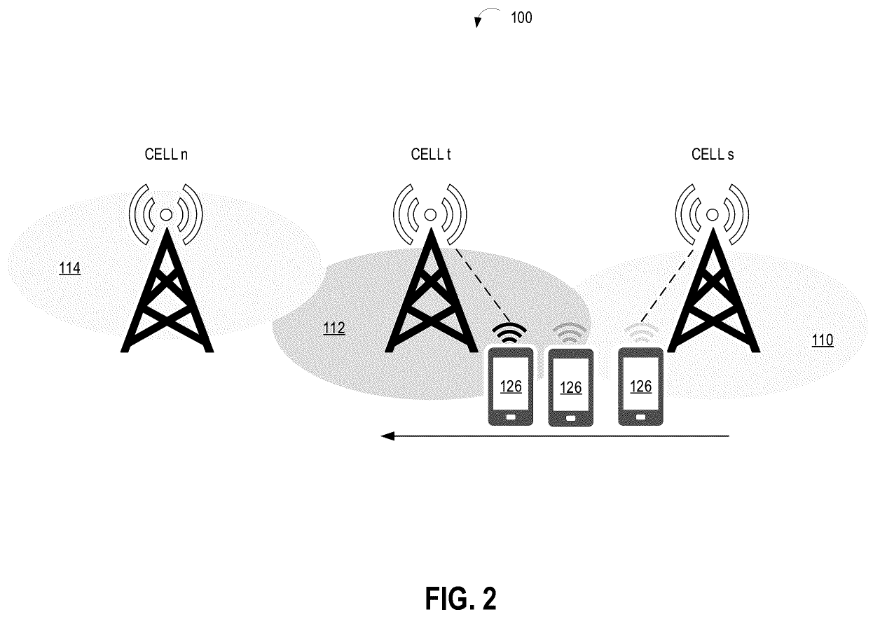

FIG. 2 illustrates how 4G and 5G systems can support device mobility. At a high level, communications service(s) such as Internet access, for example, can be provided to mobile devices using multiple radio base stations (cells), each of which covers a geographical area. FIG. 2 illustrates three examples of such cells, e.g., cell s, cell t, and cell n, where each of the cells s, t, and n provides a particular geographical coverage area. In this example, cell s provides wireless communications (e.g., Internet access) within or over coverage area 110A, cell t provides service across coverage area 112, and cell n provides service across coverage area 11. It should be understood that certain geographical areas can also be covered by multiple cells. As illustrated in FIG. 2, it can be seen that coverages areas 110 and 112 overlap, while coverage areas 112 and 114 overlap. As a device leaves a current serving cell's radio coverage area, Internet access is maintained by migrating a device from the current serving cell to a new target cell.

It should also be understood that cells s, t, and n may belong to/be operative in the same or different types of networks. For example, cell s may belong to a 5G network, while cell t belongs to an EPS system. 5G systems include both stand-alone (SA) and non-stand-alone (NSA) architectures, the different being that the SA architecture connects the 5G radio directly to the 5G core network. In contrast the NSA architecture utilizes 4G core control signaling for the 5G RAN (i.e., it is built on/over a 4G network, using an evolved packet core (EPC) network and UEs connect to NR over 4G to access the EPC) versus the 5G-independent operation of the SA architecture. The SA of a 5G network may not be able to support voice call service, and thus, relies on an EPS (the EPC core network), and when a UE registered with the 5G system requests a voice call service, the UE must fall back to the EPS, necessitating a handover between systems.

In the example of FIG. 2, smartphone 126 is shown to be receiving service from cell s (current serving cell) while smartphone 126 is located within coverage area 110. As smartphone 126 moves or travels towards cell t, it can be appreciated that smartphone 126 may continue to receive service from cell s, but as noted above, the coverage area 110 may overlap with coverage area 112 closer to cell t. Upon traversing past this overlap of coverage areas 110 and 112, smartphone 126 may handover to cell t (target serving cell), and begin receiving service from cell t. In reality, handovers can be frequent, e.g., every 70 s on average in walking scenarios, every 8.6 s on average when traveling by railways, and can be more frequent still with the deployment of 5G dense small cells. It should be understood that 5G dense small cells may provide superior speed/throughput/latency to 4G cells, but the radio waves (mmWave) used in the high-band 5G spectrum for small cells are much more susceptible/sensitive to being blocked by obstacles, e.g., buildings, trees, etc. and thus their coverage areas are smaller. Thus, handovers can be more frequent.

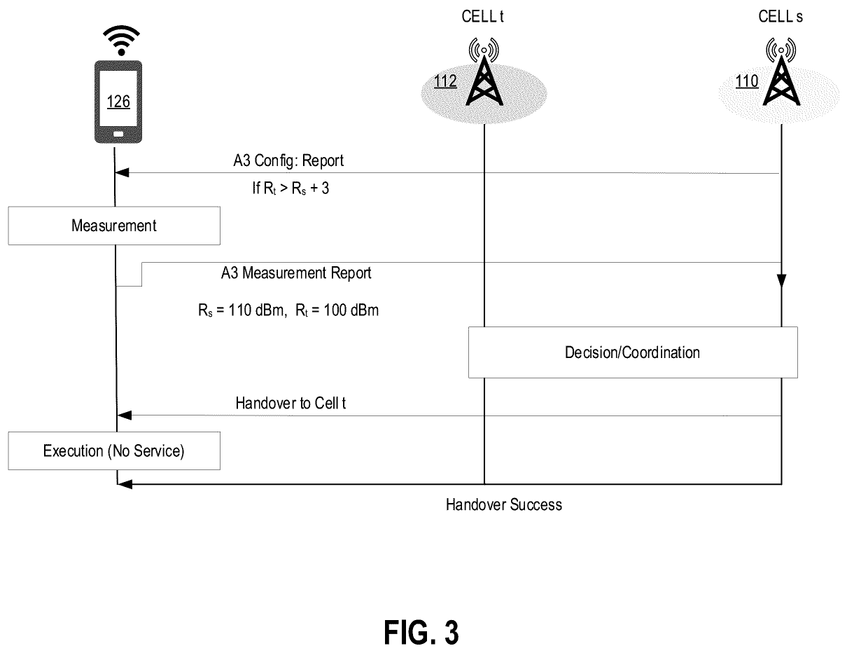

FIG. 3 illustrates certain events/actions that can occur/be performed to effectuate a handover. Following the example of FIG. 2, smartphone 126 moves from coverage area 110 (served by cell s) to coverage area 112 (served by cell t). Once smartphone 126 connects to its serving cell (cell s), the serving cell s asks smartphone 126 to monitor the serving cell's (cell s's) and the target cell's (cell t's) signal strengths. Serving cell s configures smartphone 126 with “standard” thresholds and triggering event conditions of the signal strengths (discussed in greater detail below), e.g., if a target cell's (cell t's) signal is weaker than that of the serving cell (cell s). Smartphone 126 may perform signal strength measurements, and If any event criteria are satisfied, smartphone 126 reports the signal strength measurement results to serving cell s send a measurement report back to cell s (which at one point may reflect that cell s's signal strength, Rs (e.g., 110 dBm) is less than that of cell t, Rt (e.g., 100 dBm)). Upon receiving the measurements, serving cell s runs its local handover decision algorithms, and may reconfigure smartphone 126 for further measurements (with updated events/thresholds), or send a handover command to smartphone 126. At some point, as smartphone 126 gets closer to cell t, cell t's signal strength will begin to improve and will eventually surpass that of cell s, at which point a decision to handover service for smartphone 126 from serving cell s to target cell t is made. On receiving the handover command, smartphone 126 will disconnect from the serving cell, and connect to target cell t. During that handover execution, there is no service until smartphone 126 completes disconnection from cell s and connection to cell t (for a successful handover).

It should be understood that redirection (a type of handover) can also be performed when a UE, e.g., smartphone 126 leaves a cell, e.g., cell s and enters the coverage of cell t. Upon entry into the coverage area of cell t, smartphone 126 also changes from its current “connected” state to an idle mode. The source ENB (of cell s) releases its connection to smartphone 126, will instruct smartphone 126 to redirect itself to the target ENB (of cell t) by indicating the requisite carrier frequency or cell id. With both handover and redirection, movement to another RAT/cell is prompted pursuant to a measurement report function.

Again, mobility/handover decisions are based on measurement reports from a UE. Multiple measurements can be taken and reported, including for example: received signal strength indicator (RSSI); reference signal received power (RSRP); reference signal received quality (RSRQ); signal to interference plus noise ratio (SINR); signal to noise ratio (SNR) to name a few. Table 1, below, presents example events (series A and B) that can be reflected in measurement reports. It should be understood that 3GPP specifications provide a defined set of measurement report mechanisms that a UE can perform, where each type of report is referred to as an event. The type of event a UE must report can be specified by radio resource control (RRC) signaling sent, e.g., from a base station of a cell to a UE.

| Event | Parameter | Range | | Value (dBm) | |
|---|---|---|---|---|---|
| A1, A2, A3, A4, A5, | RSRP threshold | 0 | 127 | −156 | −31 |
| B1 | RSRQ threshold | 0 | 127 | −40 | 20 |
| | SINR threshold | 0 | 127 | −23 | 40 |
| All | Hysteresis | 0 | 30 | 0 | 15 |
| A3, A6 | Offset | −30 | 30 | −15 | +15 |
| A3, A4, A5, A6, B1, B2 | Cell Specific Offset | | | −24 | +24 |
| | LTE RSRP | 0 | 97 | −140 | −44 |
| B1, B2 | LTE RSRQ | 0 | 34 | −19.5 | −3 |
| | LTE SINR | −23 | 40 | −23 | 40 |

Events A1-A6 apply to same/intra-RAT events while events 131 and B2 apply to inter-RAT events. Event A1 indicates that the serving cell is better than a given threshold. Event A2 indicates the serving cell becomes worse than the threshold. Event A3 indicates that a neighbor cell becomes better than a special cell by some offset. Even A4 indicates that a neighboring cell becomes better than a defined threshold. Event A5 indicates that a special cell becomes worse than a first threshold, while a neighbor cell becomes better than a second threshold (e.g., a combination of events A2 and A4). Even A6 refers to when a neighbor cell becomes better than a special cell by some defined (positive or negative) offset. Event B1 refers to an inter-RAT neighbor cell becoming better than a defined threshold, while event B2 suggests that a primary serving cell becomes worse that a first defined threshold and an inter-RAT neighbor cell is better than a second defined threshold.

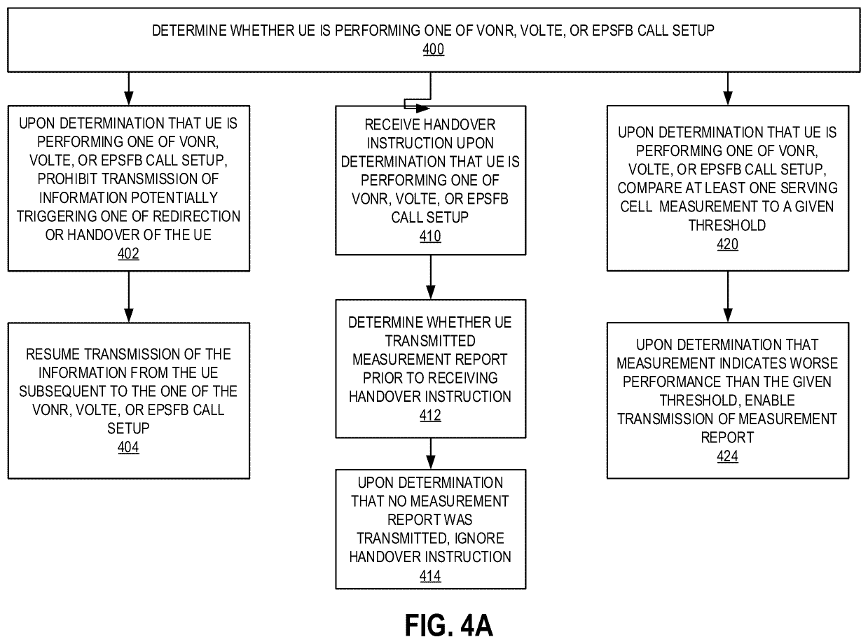

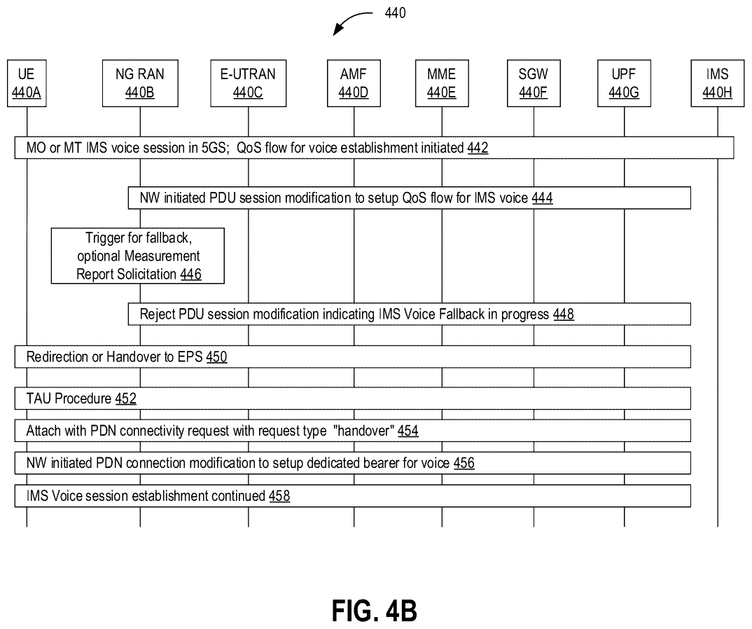

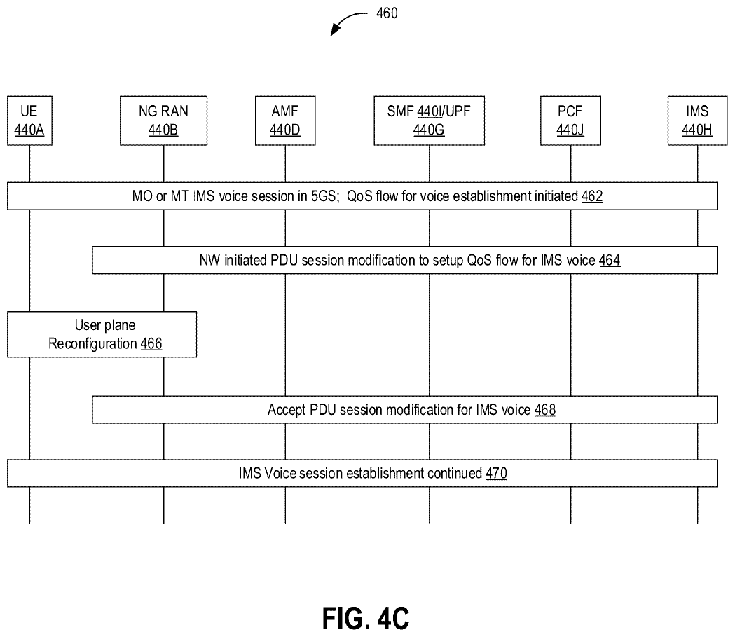

FIG. 4A illustrates operations that may be performed by a UE in accordance with various embodiments to effectuate measurement reporting prohibition or initiate measurement reporting in response to various operating conditions of the UE. At operation 400, a determination is made regarding whether or not a UE is performing one of a VoNR, VoLTE, or EPS fallback call setup.

FIG. 4B illustrates an example of an EPS fallback call setup procedure 440. FIG. 4B illustrates an example architecture with various network elements, including, but limited to a UE 440A, the next generation (NG) RAN 440B, the evolved UMTS Terrestrial RAN (E-UTRAN) 440C, the core access and mobility management function (AMF) 440D, a mobility management entity (MNME) 440E, a serving gateway (SGW) 440F, the UP function (UPF) 440G, and the IMS 440H. Those of ordinary skill in the art understand the role/function provided by such network elements. At 442, a mobile originated/terminated IMS voice session in a 5G system (5GS) is initiated between UE 440A and IMS 440H. At 444, modification to the network-initiated packet data unit (PDU) session is performed by the NG RAN 440B to setup the quality of service (QoS) flow for the IMS voice session. At 446, the NG RAN 440B triggers an optional MR request for fallback. The PDU session modification is rejected by the NG RAN 440B indicating IMS voice fallback is in progress at 448. Redirection or handover to EPS occurs at the UE at 450. A tracking area update (TAU) procedure may be performed by the UE 440A at 452, and at 454, the UE can request connectivity to a PDN with a handover request. The network initiated PDN connection is modified to setup a dedicated bearer for voice at 456, and the IMS voice session establishment procedure continues at 458.

When a UE is involved in any such operations or receives/sends any such messages (or sets of messages/operations indicating an EPS fallback call setup, the UE can, in accordance with various embodiments, prohibit the transmission of a measurement report that would trigger a redirection/handover before the EPS fallback is completed. It should be noted that EPS fallback involves redirection/handover, but it is another or different redirection/handover as a result of a measurement report aside from the EPS fallback redirection/handover that is avoided. That is, the EPS fallback call setup is allowed to continue/complete before another redirection/handover occurs. It should also be noted that even without the message flow/operations described above, the UE can, based, e.g., on RAT and IMS voice call type information, determine that an EPS fallback call setup is in progress. In particular, the UE can make such a determination based on what RAT the UE is currently on, and whether or not a fallback operation has been triggered. For example, if a UE is operating on either LTE or NR, but no fallback has yet been triggered, the call is a VoLTE or VoNR call. On the other hand, if the UE is on NR and there is a fallback triggered, the call is an EPS fallback call type. Thus, if a UE determines that an EPS fallback call setup is in progress based on this information, the UE can still prohibit the transmission of a measurement report/ignore a request for a measurement report.

FIG. 4C illustrates an example of a VoNR call setup procedure 460. It should be understood that the illustrated VoNR call setup procedure is similar to VoLTE call setup, except redirection will occur to LTE RAT rather than 5C core. FIG. 4B illustrates an example architecture with various network elements, including, but limited to UE 440A, NG RAN 440B, AMF 440D, UPF 440G/session management function (SMF) 4401, a policy control function (PCF) 440J and IMS 440H. Those of ordinary skill in the art understand the role/function provided by such network elements. At 462, similar to operation 442 (FIG. 4B), a mobile originated/terminated IMS voice session is initiated between UE 440A and IMS 440H, and the QoS flow for voice establishment can be initiated. At 464, similar to operation 444 (FIG. 4B), modification to the network-initiated packet data unit (PDU) session is performed by the NG RAN 440B to setup the quality of service (QoS) flow for the IMS voice session. At 464, the NG RAN 440B and UE 440A engage in reconfiguration of the UP. At 468, the PDU session modification for IMS voice session is accepted, and at 470, the IMS voice session establishment procedure is continued.

Again, when a UE is involved in any such operations or receives/sends any such messages (or sets of messages/operations indicating VoLTE or VoNR call setup, the UE can, in accordance with various embodiments, prohibit the transmission of/ignore a request for the transmission of a measurement report that would trigger a redirection/handover before the VoLTE/VoNR call setup is completed.

Referring back to FIG. 4A, at operation 402, upon determining that the UE is performing one of VoNR, VoLTE, or EPS fallback call setup, the transmission of information potentially triggering one of a redirection or handover of the UE is prohibited. As discussed above, when a UE is undergoing a VoLTE, VoNR, or EPS fallback call setup, but transmits a measurement report deemed by the network to necessitate redirection or handover, the redirection/handover occurs before call setup is completed, resulting in a dropped call. However, after call setup is completed, the UE may resume transmission of information from the UE at operation 404. As discussed above, in some embodiments, the information may be an aspect(s) or element(s) of a measurement report (e.g., one or more parameters associated with series A or B events). As also discussed above, in some embodiments, any/all measurement reports in their entirety are prohibited from being transmitted during VoNR, VoLTE, or EPS fallback call setup.

In some embodiments, upon determining that the UE is performing one of VoNR, VoLTE, or EPS fallback call setup, the UE may receive a handover instruction at operation 410. In certain situations, a network will instruct a UE to handover to another RAT/cell without receiving a measurement report indicative of events suggesting handover. At operation 412, the UE determines whether or not it sent a measurement report prior to receipt of the handover instruction. Upon a determination at operation 414 that the UE did not transmit a measurement report prior to receiving the handover instruction, the UE ignores the handover instruction. That is, the network attempted to initiate a blind handover which if performed before call setup is complete, would also result in a dropped call.

In still other embodiments, upon determining at operation 420 that the UE is performing one of VoNR, VoLTE, or EPS fallback call setup, the UE may compare at least one serving cell measurement to a given threshold regarding quality of service/cell performance. Such a threshold can be based, for example, on RSRP alone, with in combination with RSRQ. Ultimately, the basis on which the threshold can vary, so long as the threshold reflects some value/level indicating that the serving cell is stable enough to remain camped thereon. In some embodiments, the threshold can be derived from test data or other data indicative of cell stability. It should be understood that the threshold can be RAT dependent, e.g., an LTE-related threshold may differ from a 5G-related threshold. At operation 424, upon a determination that the serving cell measurement indicates worse performance than the threshold, the transmission of measurement reports by the UE is enabled. Again, if call setup is allowed with the UE's current serving cell, even if call setup is completed, the call is at risk of being dropped. Thus, in some embodiments, the threshold may be determined such that the threshold delineates some given potential for being dropped against potential for acceptable performance. If the serving cell's performance is deemed to be worse than the given threshold, enabling measurement reporting and undergoing redirection/handover to a better performing target cell first would be preferable to completing call setup when the probability of dropping the call that has been setup is unacceptably high.

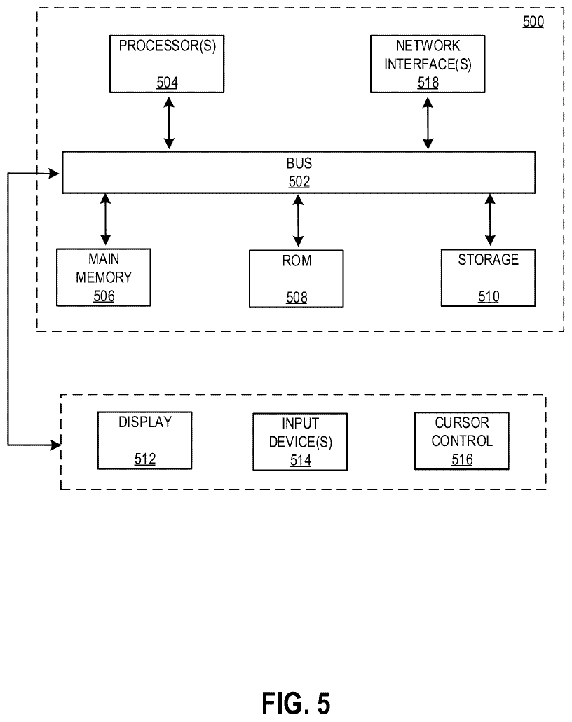

FIG. 5 is an example computing component that may be used to implement various features of embodiments described in the present disclosure. FIG. 5 depicts a block diagram of an example computer system 500 in which various of the embodiments described herein may be implemented. The computer system 500 includes a bus 502 or other communication mechanism for communicating information, one or more hardware processors 504 coupled with bus 502 for processing information. Hardware processor(s) 504 may be, for example, one or more general purpose microprocessors.

The computer system 500 also includes a main memory 506, such as a random access memory (RAM), cache and/or other dynamic storage devices, coupled to bus 502 for storing information and instructions to be executed by processor 504. Main memory 506 also may be used for storing temporary variables or other intermediate information during execution of instructions to be executed by processor 504. Such instructions, when stored in storage media accessible to processor 504, render computer system 500 into a special-purpose machine that is customized to perform the operations specified in the instructions.

The computer system 500 further includes a read only memory (ROM) 508 or other static storage device coupled to bus 502 for storing static information and instructions for processor 504. A storage device 510, such as a solid state disk (SSD), magnetic disk, optical disk, or USB thumb drive (Flash drive), etc., is provided and coupled to bus 502 for storing information and instructions.

The computer system 500 may be coupled via bus 502 to a display 512, such as a liquid crystal display (LCD) (or touch screen), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. In some embodiments, the same direction information and command selections as cursor control may be implemented via receiving touches on a touch screen without a cursor.

The computing system 500 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, bitstreams, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 510. Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media can also take the form of acoustic or light waves, such as those generated during radio-wave and infra-red data communications.

The computer system 500 also includes communication interface 518 coupled to bus 502. Communication interface 518 provides a two-way data communication coupling to one or more network links that are connected to one or more local networks. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN (or WAN component to communicate with a WAN). Wireless links may also be implemented. In any such implementation, communication interface 518 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 518, which carry the digital data to and from computer system 500, are example forms of transmission media.

The computer system 500 can send messages and receive data, including program code, through the network(s), network link and communication interface 518. In the Internet example, a server might transmit a requested code for an application program through the Internet, the ISP, the local network and the communication interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method, comprising:
determining whether a user equipment (UE) is performing a voice over internet Protocol (VoIP) call setup procedure;
upon a determination that the UE is performing a VoIP call setup, selectively enabling or disabling transmission of measurement report information to a network in which the UE is operating until the VoIP call setup procedure is complete;
wherein selective enablement of the transmission of the measurement report information depends upon a further determination that a serving cell currently serving the UE fails to meet a stability threshold; and
wherein selective disablement of the transmission of the measurement report information occurs when redirection or handover of the UE pursuant to the transmission of the measurement report information is a possibility.

2. The method of claim 1, wherein the VoIP call setup procedure comprises one of a voice over long term evolution (VoLTE) call setup procedure, a voice over new radio (VoNR) call setup procedure, or an evolved packet system (EPS) fallback call setup procedure.

3. The method of claim 1, further comprising re-enabling the transmission of the measurement report information upon completion of the VoIP call setup procedure.

4. The method of claim 1, wherein the measurement report information comprises series A-type events and series B-type events.

5. The method of claim 4, wherein the measurement report information comprises measured parameter values corresponding to one or more of the series A-type events and series B-type events.

6. The method of claim 1, wherein the measurement report information comprises an entirety of information captured in a measurement report.

7. The method of claim 1, wherein determining whether the UE is performing a VoIP call setup procedure comprises detecting VoIP call setup messages or operations involving the UE.

8. The method of claim 1, wherein determining whether the UE is performing a VoIP call setup procedure is based on a RAT of the serving cell and IMS voice call type information.

9. A user equipment (UE), comprising:
a processor; and
a memory unit including computer code that when executed causes the processor to:
enable transmission of measurement report information to a network in which the UE is operating while the UE is performing a voice over Internet Protocol (VoIP) call setup procedure upon a determination that a serving cell currently serving the UE fails to meet a stability threshold; and
disable transmission of the measurement report information when redirection or handover of the UE pursuant to the transmission of the measurement report information is a possibility.

10. The UE of claim 9, wherein the VoIP call setup procedure comprises one of a voice over long term evolution (VoLTE) call setup procedure, a voice over new radio (VoNR) call setup procedure, or an evolved packet system (EPS) fallback call setup procedure.

11. The UE of claim 9, wherein the computer code, when executed, further causes the processor to re-enable the transmission of the measurement report information upon completion of the VoIP call setup procedure.

12. The UE of claim 9, wherein the measurement report information comprises series A-type events and series B-type events.

13. The UE of claim 12, wherein the measurement report information comprises measured parameter values corresponding to one or more of the series A-type events and series B-type events.

14. The UE of claim 9, wherein the measurement report information comprises an entirety of information captured in a measurement report.

15. The UE of claim 9, wherein the computer code that when executed causes the processor to determine whether the UE is performing a VoIP call setup procedure further causes the processor to detect VoIP call setup messages or operations involving the UE.

16. A method, comprising:
pursuant to receipt of a handover instruction, determining whether a user equipment (UE) is performing a voice over internet Protocol (VoIP) call setup procedure;
further determining whether the UE transmitted a measurement report prior to receipt of the handover instruction;
upon a determination that no measurement report was transmitted by the UE ignoring the handover instruction and continue with the VoIP call setup procedure.

17. The method of claim 16, wherein the VoIP call setup procedure comprises one of a voice over long term evolution (VoLTE) call setup procedure, a voice over new radio (VoNR) call setup procedure, or an evolved packet system (EPS) fallback call setup procedure.

18. The method of claim 16, wherein the measurement report comprises series A-type events and series B-type events.

19. The method of claim 18, wherein the measurement report comprises measured parameter values corresponding to one or more of the series A-type events and series B-type events.

20. The method of claim 16, wherein determining whether the UE is performing a VoIP call setup procedure comprises detecting VoIP call setup messages or operations involving the UE.
